(19) United States
(12) Patent Application Publication
(10) Pub. No.: US 2007/0170207 A1
(43) Pub. Date: Jul. 26, 2007

(54) Bin activator apparatus

(75) Inventors: Richard B. Kraus, Crystal Lake, IL (US); Edward C. Steffes JR., Woodstock, IL (US); Rusty R. Knutson, Woodstock, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GENERAL KINEMATICS CORPORATION, Crystal Lake, IL (US)

(21) Appl. No.: 11/234,440

(22) Filed: Sep. 23, 2005

(51) Int. Cl. B65G 65/40

(52) U.S. Cl. 222/199; 222/198; 222/181.1

(57) ABSTRACT

A bin activator apparatus includes first and second motors, each motor having an eccentric weight coupled thereto. The activator apparatus also includes first and second phase angle sensors associated with the first and second motors for generating first and second position signals indicative of the positions of the eccentric weights, a controller responsive to the first and second position signals for measuring a real time phase angle between the eccentric weights, comparing the real time phase angle to a user-entered desired phase angle, and generating a phase angle error signal, and a frequency drive operably coupled to at least the first motor and responsive to the phase angle error signal for adjusting the speed of the first motor until the real phase angle is substantially equal to the desired phase angle.

### FIELD OF THE INVENTION

The present invention generally relates to vibratory process equipment and, more particularly, to a vibrating bin discharge apparatus.

### BACKGROUND OF THE INVENTION

A vibratory bin discharge apparatus is generally known in the art. For example, U.S. Pat. No. 4,545,509 (assigned to the same assignee of the present invention) discloses a bin activator apparatus for discharging material from a hopper. The activator apparatus is mounted below the bin or hopper on resilient supports and is adapted to prevent material flow when the apparatus is at rest. A single motor is resiliently coupled to the bin activator for generating a vibratory force when the apparatus is active. More specifically, the motor drives a shaft carrying an eccentric weight. The force generated by the rotating eccentric weight is amplified by a spring extending between the motor and a bowl of the bin activator apparatus. The '509 patent specifically notes that the vibrational force of the motor is in a plane below a center of gravity of the bin activator apparatus. As a result, the bin activator apparatus is driven in a “cyclonic” or pitching motion about the center of gravity of the apparatus.

The bin activator apparatus disclosed in the '509 patent is considered a two-mass system, because the motor and rotating eccentric weight are connected to the apparatus by resilient springs. The springs may be excited in a number of different directions, each direction having a natural frequency associated therewith. Consequently, the motor provided with this bin activator device must be operated within a predetermined range of speeds that are near the natural frequency of the spring in the desired direction of excitation. In addition, during start up and shut down, the motor will operate at speeds below the specified range. As a result, discharge of material during start up and shut down may be sporadic and unpredictable. Also, an inordinate amount of time may be needed for the motor to reach the specified operating speed, and, therefore, the bin activator apparatus is unsuitable for applications in which an intermittent discharge of material is desired or where the amount of material to be discharged must be precise. In the previous bin activator apparatus having only a single motor, the amplitude of the vibratory force may be adjusted only by adjusting the speed of rotation of the eccentric weight. Because of the limited range of operating speed associated with a two-mass system, adjustment of the amplitude of the vibratory force is limited.

It is generally known that greater control over the type of vibratory force generated by the apparatus may be obtained by using two motors, wherein each motor drives a separate eccentric weight. In a two-motor system, a phase angle between the eccentric weights driven by the motors may be varied to change the direction or pattern of vibratory force. As used herein, the phrase “phase angle” represents the relative positions of the eccentric weights with respect to one another as they rotate about their associated shafts. While the shafts typically rotate at the same speed so that the existing phase angle is maintained, the speed of one of the shafts may be momentarily altered to obtain a new phase angle. As the phase angle is changed, the vibratory force produced by the eccentric weights is altered, thereby changing the vibratory motion of the apparatus.

In practice, it is difficult to maintain a desired phase angle when the motor is mounted on a single, substantially rigid base. It has been found that when two or more motors are mounted on a single rigid base, the motors will tend to synchronize due to a natural phenomenon. Consequently, adjustments to the phase angle between the eccentric weights are resisted by this phenomenon, which ultimately forces the motors back into synchronization.

U.S. Pat. No. 5,615,763, Schieber, discloses a vibratory system that includes a controller for maintaining a phase angle between eccentrically weighted shafts. The '763 patent specifically discloses three rotating shafts, wherein two shafts rotate in a first direction and a third shaft rotates in a second, opposite direction. The counter-rotating shafts generate a linear vibratory motion that is used to advance material along a conveyer trough. According to the '763 patent, a sinusoidal vibratory motion is generated in which a resultant vibratory force supplied to the conveyer trough is at a pre-determined angle of attack to the conveyer trough. This motion results in non-parallel vibratory displacements of the conveyer trough with respect to a direction of conveyance. By controlling the orientation of the single shaft with respect to the other shafts, the phase angle relationship may be changed, thereby changing the angle of attack of the force supplied to the trough. While Schieber discloses components for maintaining and adjusting a phase angle between rotating shafts, it fails to disclose or suggest a circular vibratory motion useable in bin activator apparatus.

### BRIEF DISCRIPTION OF THE DRAWINGS

FIG. 1 is a side elevational view, in cross-section, of a bin activator apparatus in accordance with the teachings of the present invention;

FIG. 2 is a schematic top view of first and second motors used in the bin activator apparatus, illustrating a phase angle between eccentric weights driven by the motors; and

FIG. 3 is a schematic block diagram showing phase angle control components used in the bin activator apparatus of FIG. 1.

### DETAILED DESCRIPTION

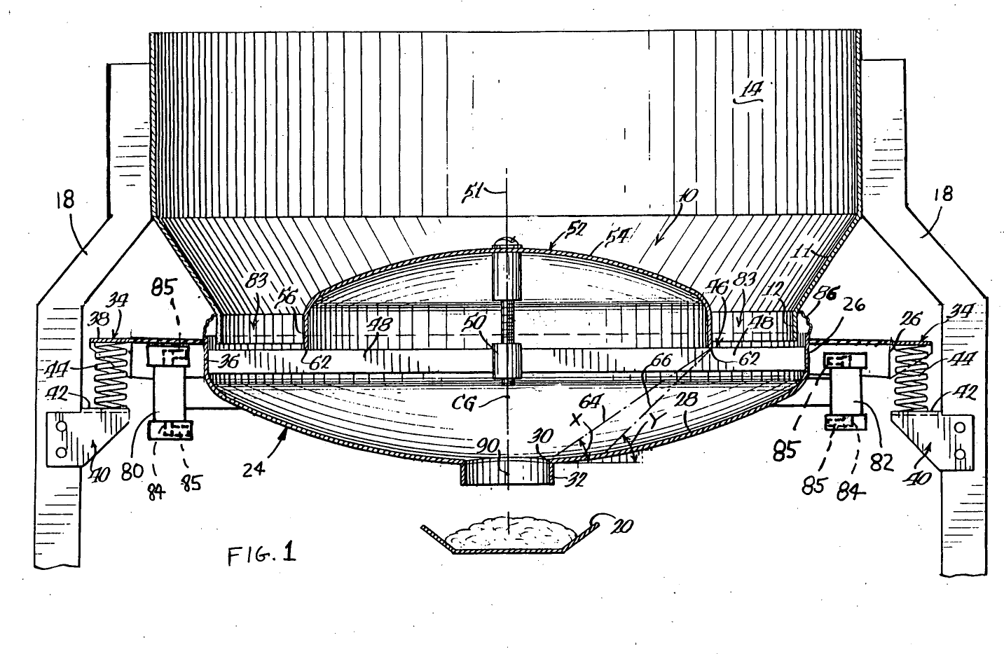

Referring now to FIGS. 1-3, a bin activator apparatus 10 is shown mounted below a sloping or cone-shaped portion 11 of a bin or hopper 14. A bottom of the cone-shaped portion 11 defines a discharge opening 12 through which material in the hopper 14 may be discharged. In the illustrated embodiment, the bin 14 is shown mounted on vertical supports 18 that are anchored to the ground in an appropriate fashion. It is contemplated that the bin or hopper 14 could be a permanent structure formed in a base, wherein a one or more sloping or cone-shaped discharge openings project downwardly into an open portion of a tunnel passage beneath the material storage area. In the event the bin activator apparatus 10 is mounted in a permanent structure, the bin activator apparatus 10 would be mounted on supports anchored the walls or to the ground of the structure over which the bin is located.

In the illustrated embodiment, the bin activator apparatus 10 is shown with an outlet opening 30 positioned above a continuous.conveyer 20 or other batch apparatus so that a uniform flow of material is discharged as the conveyer or other batch apparatus traverses the path below the bin 14. The bin discharge opening 12 discharges into the bin activator apparatus 10 with the outlet opening 30 of the bin activator apparatus aligned with the conveyer 20 conveying the material discharged from the bin to a subsequent processing location. The bin activator apparatus 10 is for use in moving any pulverulent material from coal to powders and the like.

The bin activator apparatus includes a bowl-shaped base 24 having a cylindrical peripheral wall portion 26 and a concave bottom surface 28 sloping downwardly and inwardly toward the outlet opening 30 at the mid-portion thereof. A cylindrically shaped spout 32 is affixed at the opening 30 and extends downwardly from the base 24. A resilient seal 86 is affixed between the wall 26 of the base 24 and the outside surface of the discharge opening 12 of the bin so as to confine dust and the like to the bin 14 and base 24. While the illustrated embodiment shows a discharge opening 12 and a base wall portion 26 that are cylindrical, other shapes may be used for these components.

Support brackets 34 extend-radially outward from the cylindrical wall portion 26 of the base 24, each of which includes a gusset plate 36 and a cross plate 38. Two to or more brackets 34 may be provided equidistantly spaced apart the periphery of the base 24. Each support 18 has an inwardly projecting bracket 40 secured thereto, with each bracket 40 having a horizontal plate 42 extending transverse to the support beam 18. Resilient isolators, such as compression springs 44, are mounted between brackets 34 and 40 so as to resiliently support the base 24 of the bin activator apparatus 10. The brackets 34, 40 are positioned so that the cylindrical wall portion 26 of the base 24 overlaps the wall defining the discharge opening 12 and has a reasonably uniform and predetermined spacing therebetween.

An internal support structure 46 is affixed to the inside of the base 24. As shown in FIG. 1, the support structure 46 includes radial arms 48 radiating from a hub 50, with the axis of the hub 50 substantially coinciding with a vertical axis 51 of the base 24. A deflector 52 is supported on the structure 46 and includes a dome-shaped portion 54 which terminates in a downwardly directed sleeve portion 56. Between the sleeve portion 56 of the deflector 52 and the discharge opening 12 of the bin is an annular clearance space through which material may pass. The edges 62 of the sleeve portion 56 rest on the radial arms 48.

The lower edge 62 of the deflector 52 is located with respect to the outlet opening 30 of the base 24 in such a way that the angle X to the horizontal of a line extending from the lower edge 62 to the edge of the outlet opening 30 is less than the angle of repose Y of material being discharged from the bin. This principle is best shown with reference to line 64 extending from the edge 62 to the opening 30, which has an angle X to the horizontal which is less than the angle Y formed by the line 66 drawn along the surface of the material reposing in the base 24. Accordingly, in the static condition, the material in the bin and reposing in the base 24, due to the coefficient of friction of the surface and due to the tangential slope of the concave base, the material will not flow to the outlet opening 30 so that no cut-offs or gatings are necessary to stop the flow of material from the bin.

A source of vibratory force is connected to the base 24 to create a resultant vibratory motion of the bin activator apparatus 10, thereby to discharge material through the outlet opening 30. As shown in FIG. 1, the source of vibratory force includes first and second motors 80, 82 rigidly coupled to the base 24. Each of the motors 80, 82 includes a rotating shaft 84 having an eccentric weight 85 coupled thereto. The shafts 84 driven by the first and second motors 80, 82 are generally vertically aligned and are substantially parallel to one another.

The first and second motors 80, 82 are positioned with respect to the base 24 such that a resultant force of the first and second motors substantially intersects with the center of gravity of the bin activator apparatus. In the illustrated embodiment, for example, each motor 80, 82 carries two eccentric weights 85. The weights 85 of each motor are positioned on opposite sides of a horizontal line passing through a center of gravity CG of the bin activator apparatus such that, when viewed from the side as shown in FIG. 1, the center of gravity of each motor is substantially coincident with the horizontal line passing through the bin activator apparatus center of gravity CG. Furthermore, the combined centers of gravity of the motors 80, 82 is substantially coincident with a vertical reference line 51 passing through the bin activator apparatus center of gravity CG. By positioning the motors 80, 82 in this manner, the resultant force generated by the motors 80, 82 will substantially intersect with the bin activator apparatus center of gravity CG.

When material is piled in the bin 14, it will completely fill the discharge opening 12 in the bin and will flow through clearance space 83 to form the angle of repose Y between the edge 62 of the deflector 52 and the concave surface 28 of the base 24. The angle of repose Y is greater than the angle X between line 64 extending form the edge 62 to the edge of the opening 30. In this way, due to the coefficiental friction of the surface acting on the material, and due to the angle of the surface to the horizontal, no material will flow through the outlet opening 30 when the bin activator apparatus 10 is at rest. When the first and second motors 80, 82 are started, the base 24 and deflector 52 are moved in a circular motion which permits flow of materials through the outlet opening 30.

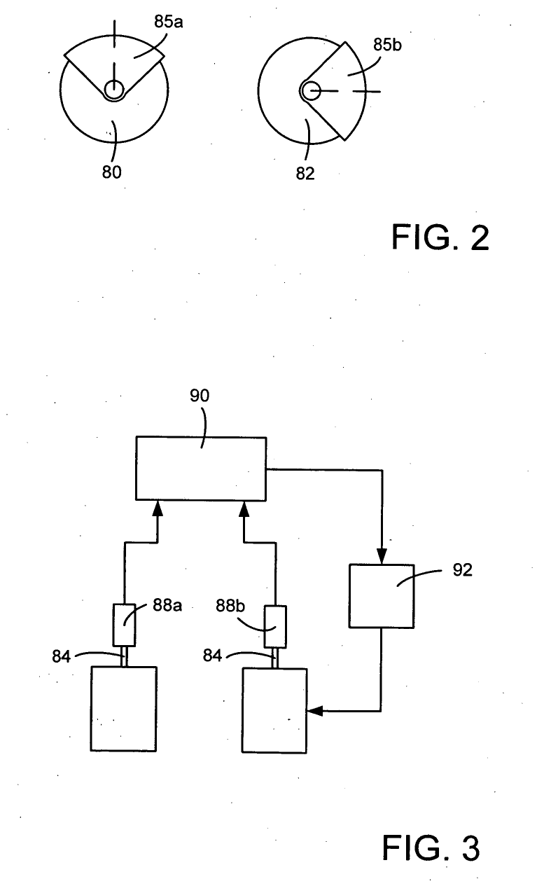

The relative positions of the eccentric weights 85 on the shaft 84 define a phase angle relationship. As shown in FIG. 2, for example, the eccentric weight 85a on the shaft driven by the first motor 80 is at a 12 o'clock or 0° position, while the eccentric weight 85b on the shaft driven by the second motor 82 is at a three o'clock or 90° position. The phase angle of eccentric weights 85a, 85b is found by determining the angle between the positions of the eccentric weights at a given moment in time. In the illustrated example, the phase angle relationship between the eccentric weights is 90°. It will be appreciated that any phase angle from 0° to 360° is possible. In general, the first and second motors 80, 82 are operated at substantially the same speeds so that the phase angle relationship is maintained during operation of the apparatus 10.

A system is provided for controlling the relative phase angle of the shafts 85 with respect to one another, as illustrated in FIG. 3. Phase angle sensors, such as shaft encoders 88a, 88b are provided for sensing the position of the shafts 84. Because the position of the eccentric weight 85 with respect to their associated shafts is fixed, the 5 position of the eccentric weights 85 may be inferred from the position of the shafts 84. The position information gathered by the encoders 88 is continuously provided by first and second position signals to a controller 90. A controller 90 is responsive to the first and second position signals from the encoders 88 to generate a real phase angle signal corresponding to the phase angle difference of the eccentric weights. A controller 90 compares the real phasing signal to a user-entered desired phase angle and generates an error signal representing the difference between the real phase angle and the user-entered desired phase angle. The phase angle error signal is forwarded to a frequency drive 92 operably coupled to one of the first and second motors 80, 82. In the illustrated embodiment, the frequency drive 92 is operably coupled to the first motor 80; however it will be appreciated that the frequency drive 92 may be operably coupled to the second motor 82, or that first and second frequency drives may be operably coupled to the first and second motors 80, 82, respectively. The frequency drive 92 will adjust the speed of the associated motor until the real phase angle is substantially equal to the desired phase angle.

Because the first and second motors 80, 82 are rigidly coupled to a common, rigid base 24, the natural phenomenon noted above continuously biases the motors toward a synchronized state. Accordingly, the controller 90 will typically continuously adjust the operating speed of the first motor 80 to maintain the desired phase angle between the eccentric weights.

The two-motor system described herein generates a vibratory force that results in a circular motion of the bin activator apparatus 10. The motors 80, 82 may be rotated in the same direction to generate the vibratory force. Because this force is applied at the bin activator apparatus center of gravity CG, the force will move the base 24 such that all points on the base will move in the same circular motion. The amplitude of the bin activator may be modified by adjusting the phase angle between the eccentric weights 85 or the weight settings of both the first and second motors 80, 82.

Because the first and second motors 80, 82 are rigidly coupled to the base 24, the bin activator apparatus 10 may be operated over a wider range of motor speeds than are available in a two-mass system. In addition, by allowing for adjustment of the phase angle between the eccentric weights 85, the rate of material discharge may be more precisely adjusted.

The foregoing detailed description has been given for clearness of understanding only, and no unnecessary limitations stood therefrom, as modifications would be obvious to those skilled in the art.

What is claimed is:

1. A bin activator apparatus for moving material from a storage bin having a discharge opening in the bottom thereof, the apparatus comprising:
a substantially rigid base positioned below the storage bin and sized to receive material from the storage bin discharge opening, the base defining a discharge outlet at a midpoition thereof;
a deflector attached to the base, the deflector being positioned above the base and adjacent the storage bin discharge opening, wherein a clearance space is defined between an outer edge of the deflector and the storage bin discharge opening through which material passes;
resilient isolators attached to the base for supporting the base relative to the storage bin;
first and second motors substantially rigidly coupled to the base, each of the first and second motors driving a shaft having an eccentric weight coupled thereto, the shafts of the first and second motors being oriented substantially parallel, the first and second motors being positioned on the base so that a combined center of gravity of the first and second motors is substantially coincident with a center of gravity of the bin activator apparatus;
first and second phase angle sensors associated with the first and second motors, respectively, for generating first and second position signals indicative of the positions of the eccentric weights;
a controller responsive to the first and second position signals for measuring a real time phase angle between the eccentric weights of the first and second motors, comparing the real time phase angle to a user-entered desired phase angle, and generating a phase angle error signal; and
a frequency drive operably coupled to at least the first motor and responsive to the phase angle error signal for adjusting the speed of the first motor until the real phase angle is substantially equal to the desired phase angle;
wherein the first and second motors rotate the first and second motor shafts so that the eccentric weights generate a radial force that substantially intersects the bin activator apparatus center of gravity.

2. The apparatus of claim 1, in which the first and second phase angle sensors comprise first and second shaft encoders, respectively.

3. The apparatus of claim 1, in which the desired phase angle between the first and second eccentric weights is between 0 and 360 degrees.

4. The apparatus of claim 1, in which the radial force generates a circular motion of all points of the base.

5. The apparatus of claim 1, in which the resilient isolators comprise springs.

6. A method of discharging material through a clearance space between a discharge opening of a storage bin and a deflector coupled to a base, wherein a first and second motor are rigidly coupled to the base, each of the first and second motors including a rotatable shaft carrying an eccentric weight, the method comprising:
rotating the first and second motors so that the eccentric weights apply a radial force to the base;
monitoring relative positions of the eccentric weights of the first and second motors;
determining a real time phase angle between the eccentric weights of the first and second motors;
comparing the actual phase angle to a desired phase angle; and
adjusting the speed of at least one of the first and second motors until the real time phase angle is substantially equal to the desired phase angle.

7. The method of claim 6, in which the first and second motors are positioned on the base so that a combined center of gravity of the first and second motors is substantially coincident with a center of gravity of the base, wherein the resulting radial force intersects the base center of gravity.

8. The method of claim 7, in which the radial force generates a circular motion of all points of the base.

9. The method of claim 6, in which first and second phase angle sensors are associated with the first and second motors, respectively, for monitoring the relative positions of the eccentric weights.

10. The method of claim 9, in which the first and second phase angle sensors comprise first and second shaft encoders, respectively.

11. The method of claim 6, in which a frequency drive is provided for adjusting the speed of at least one of the first and second motors.
